(19) United States
(12) Patent Application Publication
(10) Pub. No.: US 2017/0055199 A1
(43) Pub. Date: Feb. 23, 2017

(54) ENHANCED POWER REDUCTION IN MESH NETWORKS

(71) Applicant: TerraNet AB, LUND (SE)

(72) Inventors: Johan Petersen, Malmo (SE); Monthadar Al Jaberi, Malmo (SE)

(21) Appl. No.: 14/832,015

(22) Filed: Aug. 21, 2015

(51) Int. Cl. H04W 40/24; H04W 28/02; H04W 52/02

(52) U.S. Cl. CPC H04W 40/246; H04W 52/02; H04W 28/0268; H04W 84/18

(57) ABSTRACT

A method for a mesh network is disclosed. The mesh network comprises a first station, a second station and one or more intermediate stations. The communication within the mesh network is transmitted on a plurality of communication channels.

The method comprises initiating a communication by the first station with the second station of the mesh network. The first station, the second station and the one or more intermediate stations together define a mesh path for the communication.

The method also comprises defining by the first station a quality of service—QoS—class which indicates a desired level of quality of the communication.

The method continues with determining available communication channels out of the plurality of communication channels based on the QoS and setting by the first station a limited number of mesh awake windows—MAW—as available for each available communication channel based on the QoS class.

Then the first station, according to the method, defines a MAW map comprising the available MAWs for each available communication channel, embeds the QoS class and the MAW maps in the PREQ frame and broadcasts a path request—PREQ—frame comprising the QoS class and the MAW maps to the second station during a Mesh Management Window—MMW. Also disclosed is a first, second and intermediate station as well as a respective method for a first, second and intermediate station

### TECHNICAL AREA

The present invention relates generally to the technical area of mesh networks. More particularly, it relates to reducing power consumption and increase throughput within a mesh network.

### BACKGROUND

A mesh network comprises nodes or stations which communicate with each other without the aid of a central control, such as a base station.

The stations themselves keep tracks of neighboring stations, or peers, and the communication between stations may be relayed by multihop through one or more intermediate peers from one station to another.

Mesh networks are created according to the IEEE 802.11 Mesh standard which defines mesh protocols. In order to keep track on neighboring peers and be able to detect new peers entering the network, the stations are configured according to the 802.11 Mesh Protocol to broadcast mesh beacons. Each station may broadcast a mesh beacon at certain periods in order to gain an update of neighbors in the mesh network,

The Peer Protocol results in linearly increased power consumption as the mesh network expands with new stations entering the network.

In order to save power within the mesh network, the 802.11 Mesh Power Save Mode dictates that stations may enter sleep mode in an unsynchronized manner in relation to other mesh stations in the network.

However, the Power Save Mode results in an increased latency within the network and, hence, a less efficient mesh network.

Mesh networks also often suffer from congestion and contention since several stations may try to communicate on the same network resources at the same time.

Overall, there is a need for a mesh network with less risk of congestion and contention, better throughput and higher power efficiency.

### SUMMARY

It is an object of some embodiments to mitigate at least some of the above disadvantages and to provide a method for a first, second and intermediate station as well as a first, second and intermediate station of a mesh network configured to reduce the risk of congestion in the mesh network.

According to a first aspect, this is achieved by a method for a mesh network. The mesh network comprises a first station, a second station and one or more intermediate stations. The communication within the mesh network is transmitted on a plurality of communication channels.

The method comprises initiating a communication by the first station with the second station of the mesh network. The first station, the second station and the one or more intermediate stations together define a mesh path for the communication.

The method also comprises defining by the first station a quality of service—QoS—class which indicates a desired level of quality of the communication.

The method continues with determining available communication channels out of the plurality of communication channels based on the QoS and setting by the first station a limited number of mesh awake windows—MAW—as available for each available communication channel based on the QoS class.

Then the first station, according to the method, defines a MAW map comprising the available MAWs for each available communication channel, embeds the QoS class and the MAW maps in the PREQ frame and broadcasts a path request—PREQ—frame comprising the QoS class and the MAW maps to the second station during a Mesh Management Window—MMW.

In some embodiments, the QoS class further defines a communication type being at least one of a voice communication, transmission of service data packets, and/or transmission of communication data packets.

In some embodiments, at least one MAW of each MAW map pertaining to the available communication channels is reserved for voice communication.

In some embodiments, the method comprises for each of the one or more intermediate stations along the mesh path upon receiving the PREQ:

indicating in the MAW map of each available communication channel which MAWs are available for the communication based on the QoS class and removes congested MAWs from the MAW map of each available communication channel;

determining if the MAW map for each available communication channel is sufficient to transmit the communication based on the QoS class; and

if it is determined that the MAW map for each available communication channel is not sufficient to transmit the communication based on QoS, thus indicating an unavailable channel,

discarding the PREQ; or

if it is determined that the MAW map for each available communication channel is sufficient to transmit the communication based on QoS, thus indicating an available channel,

broadcasting the PREQ comprising the MAW map for each available communication channel.

In some embodiments, the second station, upon receiving the PREQ comprising the MAW map for each available communication channel, determines which one or more of the available communication channels and which MAWs in the MAW maps pertaining to the one or more of the available communication channels should be used for the communication based on the available communication channels, QoS class and indicated available MAWs. The second station defines a final MAW map comprising the one or more available communication channel and the MAWs to be used for the communication and transmits a path reply—PREP—frame comprising the final MAW map to the first station or discards the PREQ if it is determined that no of the one or more available communication channels or the MAWs should be used for the communication.

In some embodiments, the method further comprises receiving by the first station the PREP frame from the second station, wherein the PREP frame comprises the final MAW map; and transmitting by the first station the communication on the available MAWs of the final MAW map along the mesh path; or transmitting by the first station a new PREQ and a new MAW map if the second station determines that no MAWs of the MAW map should be used for communication.

A second aspect is a network station, comprising a controller, wherein the network station is configured to operate as a first station in a mesh network. The mesh network comprises a second station and one or more intermediate stations and communication within the mesh network is transmitted on a plurality of communication channels.

The first station is configured to initiate communication with the second station of the mesh network, wherein the first station is configured to define a mesh path for communication in cooperation with the second station and the one or more intermediate stations.

The first station is also configured to define a quality of service—QoS—class indicating a desired level of quality of the communication type and to cause the first station to set one or more of the plurality of communication channels as available based on the QoS class.

The first station is further configured to set a limited number of mesh awake windows—MAW—as available for each available communication channel based on the QoS class and to define a MAW map for each available communication channel comprising the available MAWs.

The first station is configured to then embed the QoS class and the MAW maps for each available communication channel in a path request—PREQ—frame.

The first station is configured to broadcast the PREQ frame comprising the QoS class and the MAW maps for each available communication channel to the second station during a Mesh Management Window—MMW.

A third aspect is a method for a station being a first station in a mesh network comprising a second station and one or more intermediate stations wherein communication within the mesh network is transmitted on a plurality of communication channels. The method comprises initiating a communication with the second station of the mesh network by transmitting through the one or more intermediate stations a path request—PREQ—frame to the second station during a Mesh Management Window—MMW. The first station defines a mesh path for the communication in cooperation with the second station and the one or more intermediate stations.

The method further comprises defining a quality of service—QoS—class indicating a desired level of quality of the communication and setting one or more of the plurality of communication channels as available based on the QoS class.

Then the method comprises setting a limited number of mesh awake windows—MAW—as available for each available communication channel based on the QoS class and defining a MAW map for each available communication channel comprising the available MAWs.

Then the method comprises embedding the QoS class and the MAW map for each available communication channel in the PREQ frame and broadcasting the at least one PREQ frame comprising the QoS class and the MAW map to the second station during the MMW.

In some embodiments, the first station, prior to defining the MAW map for each available communication channel, determines if the available communication channels comprising the available MAWs are sufficient for transmitting the communication based on the QoS class, if it is determined that the available communication channels comprising the available MAWs are not sufficient for transmitting the communication based on the QoS class, the first station waits for a next MMW before creating the MAW map.

In some embodiments, the controller pertaining to the second aspect may be configured to cause the station to perform the method as described by the third aspect.

A fourth aspect is a network station comprising a controller, the network station being configured to operate as an intermediate station in a mesh network which comprises a first station and a second station and wherein communication within the mesh network is transmitted on a plurality of communication channels.

The intermediate station is configured to receive a path request—PREQ—frame from the first station in the mesh network to the second station in the mesh network, wherein the PREQ is for initiating a communication between the first and second station. The PREQ frame comprises a limited number of mesh awake windows—MAWs—defining a MAW map for each available communication channel and a quality of service—QoS—class indicating a desired level of quality of the communication.

The intermediate station is configured to cause the intermediate station to indicate MAWs available for the communication in the MAW map for each available communication channel based on the QoS class and remove congested MAWs from the MAW map for each available communication channel.

The intermediate station is configured to remove the entire MAW map pertaining to an available channel if too many of the available MAWs are congested based on the QoS class.

The intermediate station is further configured to determine if the MAW map for each available communication channel is sufficient for transmitting the communication in relation to the QoS class.

The intermediate station is configured forward the PREQ comprising the MAW maps for each available communication channel to the second station if the intermediate station determines that the MAW maps for each available channel is sufficient for transmitting the communication in relation to the QoS class, or to discard the PREQ if the intermediate station determines that the MAW maps for each available channel is not sufficient for transmitting the communication in relation to the QoS class.

A fifth aspect is a method for a network station being an intermediate station in a mesh network which comprises a first station and a second station and wherein communication within the mesh network is transmitted on a plurality of communication channels. The method comprises receiving a path request—PREQ—frame from the first station in the mesh network to the second station in the mesh network for initiating a communication between the first and second station.

The PREQ frame comprises a limited number of mesh awake windows—MAWs—defining a MAW map for each available communication channel and a quality of service—QoS—class which indicates a desired level of quality of the communication.

The method comprises indicating MAWs available for the communication in the MAW map for each available communication channel based on the QoS class and remove congested MAWs from the MAW map for each available communication channel.

The method also comprises removing the entire MAW map pertaining to an available channel if too many of the available MAWs are congested based on the QoS class, and determining if the MAW map for each available communication channel is sufficient for transmitting the communication in relation to the QoS class.

If it is determined that the MAW map is sufficient for transmitting the communication in relation to the QoS class, the method comprises forwarding the PREQ comprising the MAW maps for each available communication channel to the second station.

If it is determined that the MAW map is not sufficient for transmitting the communication in relation to the QoS class the method comprises discarding the PREQ.

In some embodiments, the controller pertaining to the fourth aspect may be configured to cause the station to perform the method as described by the fifth aspect.

A sixth aspect is a network station comprising a controller. The network station is configured to operate as a second station in a mesh network which comprises a first station and one or more intermediate stations and communication within the mesh network is transmitted on a plurality of communication channels.

The second station is configured to receive a path request—PREQ—frame from the first or the one or more intermediate stations in the mesh network for initiating a communication between the first and second station. The PREQ frame comprises a limited number of mesh awake windows—MAWs—defining a MAW map for each available communication channel and a quality of service—QoS—class indicating a desired level of quality of the communication.

The second station is configured to cause the second station to indicate MAWs available for the communication in the MAW map for each available communication channel based on the QoS class and to remove congested MAWs from the MAW map for each available communication channel.

The second station is also configured to remove the entire MAW map pertaining to an available channel if too many of the available MAWs are congested based on the QoS class.

The second station is configured to determine if the MAW map for each available communication channel is sufficient for transmitting the communication in relation to the QoS class;

The second station is also configured to determine which MAWs in the MAW map for each available communication channel should be used for the communication based on the indicated available MAWs by defining a final MAW map comprising the MAWs and the available communication channels to be used for the communication.

The second station is configured to transmit a Path reply—PREP—frame comprising the final MAW map through the intermediate station to the first station or the second station is configured to discard the PREQ if the second station determines that no MAWs in the MAW map should be used for the communication based on the indicated available MAWs in the MAW map for each available communication channel.

A seventh aspect is a method for a network station being a second station in a mesh network which comprises a first station and one or more intermediate stations and communication within the mesh network is transmitted on a plurality of communication channels.

The method comprises receiving a path request—PREQ—frame from the first or the one or more intermediate stations in the mesh network for initiating a communication between the first and second station.

The PREQ frame comprises a limited number of mesh awake windows—MAWs—defining a MAW map for each available communication channel and a quality of service—QoS—class indicating a desired level of quality of the communication.

The method comprises indicating MAWs available for the communication in the MAW map for each available communication channel based on the QoS class and remove congested MAWs from the MAW map for each available communication channel.

The method also comprises removing the entire MAW map pertaining to an available channel if too many of the available MAWs are congested based on the QoS class.

The method comprises determining if the MAW map for each available communication channel is sufficient for transmitting the communication in relation to the QoS class and to determine which MAWs in the MAW map for each available communication channel should be used for the communication based on the indicated available MAWs by defining a final MAW map comprising the MAWs and the available communication channels to be used for the communication.

The method then comprises transmitting a Path reply—PREP—frame comprising the final MAW map through the one or more intermediate stations to the first station or discarding the PREQ if the second station determines that no MAWs in the MAW map should be used for the communication based on the indicated available MAWs in the MAW map for each available communication channel.

In some embodiments, the controller pertaining to the sixth aspect may be configured to cause the station to perform the method as described by the seventh aspect.

An advantage of some of the aspects and embodiments disclosed herein is that a congestion and contention within a wireless mesh network is significantly reduced.

Another advantage is that the amount of power consumption within the mesh network is reduced.

Another advantage is that overall throughput within the mesh network is increased resulting in an efficient and reliable mesh network.

Another advantage of some of the aspects and embodiments is that a station within a mesh network only needs to keep track on the stations within a communication path and not on all peers.

### BRIEF DESCRIPTION OF THE DRAWINGS

Further objects, features and advantages will appear from the following detailed description of embodiments, with reference being made to the accompanying drawings, in which:

FIG. 1a and FIG. 1b are schematic drawings each illustrating a mesh station according to some embodiments;

FIG. 2 is a schematic drawing illustrating a computer program product according to some embodiments;

FIG. 3 is a schematic drawing illustrating a mesh network according to some embodiments;

FIG. 4 is a block diagram illustrating a method for a first station according to some embodiments;

FIG. 5 is a block diagram illustrating a method for an intermediate station according to some embodiments;

FIG. 6 is a block diagram illustrating a method for a second station according to some embodiments;

FIG. 7 is a combined signaling and flowchart diagram illustrating a method according to some embodiments; and

FIG. 8 is a schematic drawing illustrating a mesh network according to some embodiments.

### DETAILED DESCRIPTION

Like numbers refer to like elements throughout.

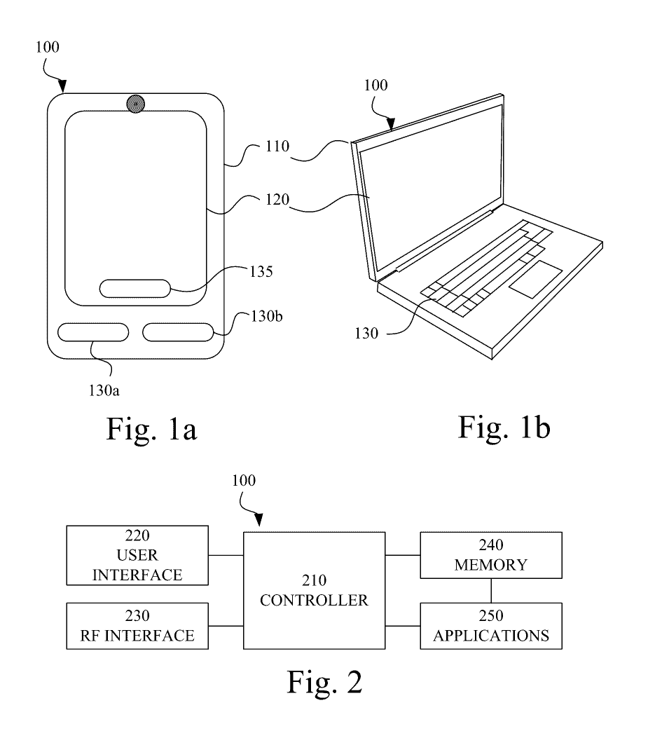

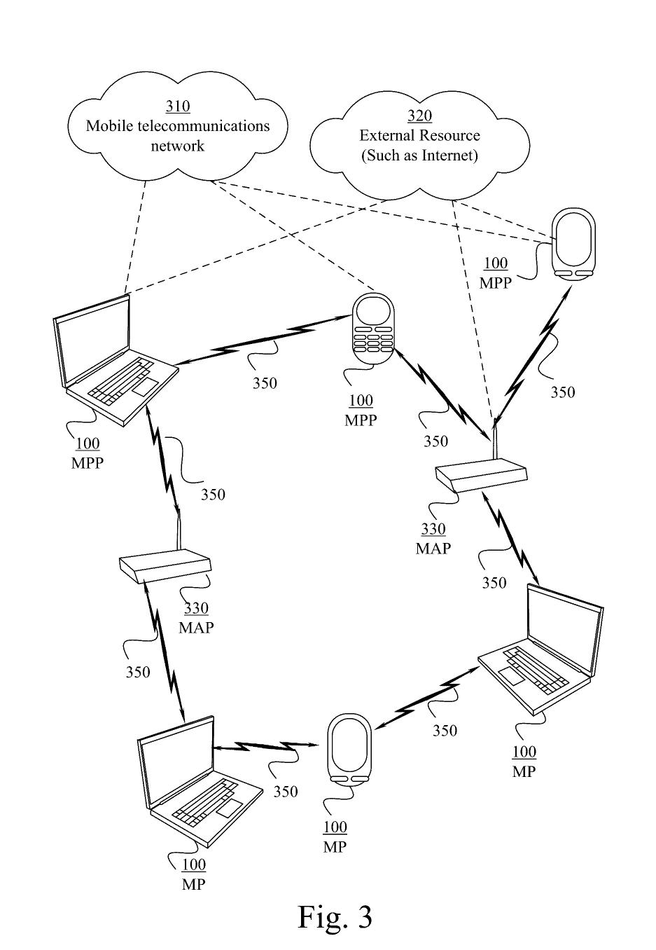

FIGS. 1a and 1b generally show a station 100 according to an embodiment herein. In one embodiment the station 100 is configured for wireless or radio frequency network communication for acting as a node (or station, the terms may be used interchangeably in this disclosure) in a mesh network. An example of a mesh network will be described with reference to FIG. 3. Examples of such a station 100 are: a personal computer, desktop or laptop, a tablet computer, a mobile telephone, a smart phone and a personal digital assistant.

Two embodiments will be exemplified and described as being a smartphone in FIG. 1a and a laptop computer 100 in FIG. 1b.

Referring to FIG. 1a, a smartphone 100 comprises a housing 110 in which a display 120 is arranged. In one embodiment the display 120 is a touch display. In other embodiments the display 120 is a non-touch display. Furthermore, the smartphone 100 comprises two keys 130a, 130b. In this embodiment there are two keys 130, but any number of keys is possible and depends on the design of the smartphone 100. In one embodiment the smartphone 100 is configured to display and operate a virtual key 135 on the touch display 120. It should be noted that the number of virtual keys 135 are dependant on the design of the smartphone 100 and an application that is executed on the smartphone 100.

Referring to FIG. 1b, a laptop computer 100 comprises a display 120 and a housing 110. The housing comprises a controller or CPU (not shown) and one or more computer-readable storage mediums (not shown), such as storage units and internal memory. Examples of storage units are disk drives or hard drives. The station 100 further comprises at least one data port. Data ports can be wired and/or wireless. Examples of data ports are USB (Universal Serial Bus) ports, Ethernet ports or WiFi (according to IEEE standard 802.11) ports. Data ports are configured to enable a station 100 to connect with other stations or a server.

The station 100 further comprises at least one input unit such as a keyboard 130. Other examples of alternative or additional input units are computer mouse, touch pads, touch screens or joysticks to name a few.

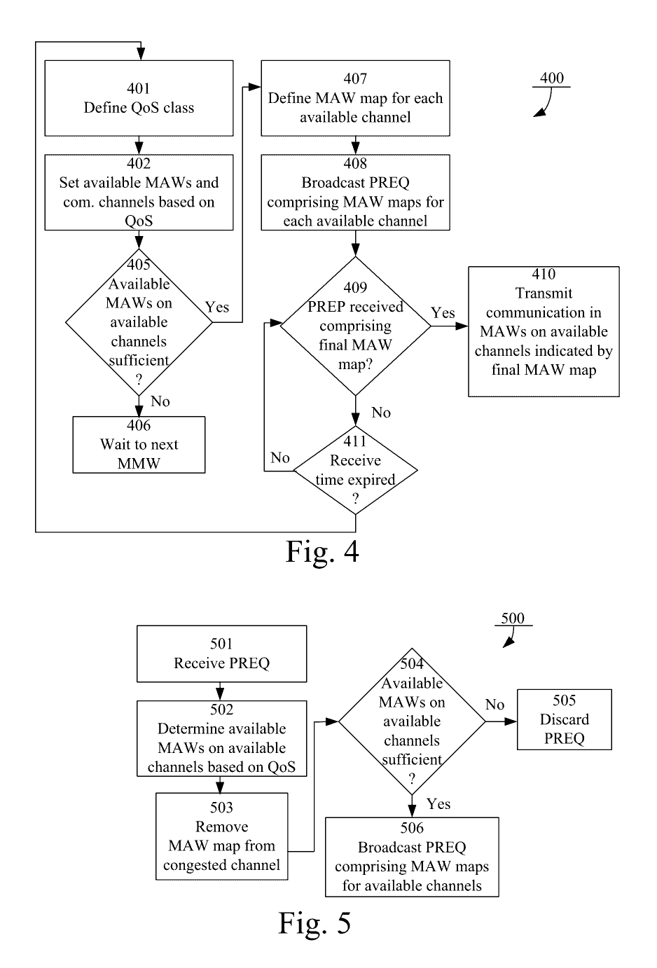

FIG. 2 shows a schematic view of the general structure of a station according to FIGS. 1a and 1b. The station 100 comprises a controller 210 which is responsible for the overall operation of the station 100 and is preferably implemented by any commercially available CPU (“Central Processing Unit”), DSP (“Digital Signal Processor”) or any other electronic programmable logic device. The controller 210 may be implemented using instructions that enable hardware functionality, for example, by using executable computer program instructions in a general-purpose or special-purpose processor that may be stored on a computer readable storage medium (disk, memory etc) 240 to be executed by such a processor. The computer readable medium 240 may be loaded with program instructions configured to be carried out and executed by the controller. Such program instructions may for example correspond to the methods described in any of the FIGS. 4, 5, 6, and 7.

The controller 210 is configured to read instructions from the memory 240 and execute these instructions to control the operation of the station 100. The memory 240 may be implemented using any commonly known technology for computer-readable memories such as ROM, RAM, SRAM, DRAM, CMOS, FLASH, DDR, SDRAM or some other memory technology. The memory 240 is used for various purposes by the controller 210, one of them being for storing application data and program instructions 250 for various software modules in the station 100. The software modules include a real-time operating system, drivers for a user interface, an application handler as well as various applications 250. The applications are sets of instructions that when executed by the controller 210 control the operation of the station 100. The applications 250 can include a messaging application such as electronic mail, a browsing application, a media player application, as well as various other applications 250, such as applications for voice calling, video calling, document reading and/or document editing, an instant messaging application, a calendar application, a control panel application, one or more video games, a notepad application, Short Message Service applications, location finding applications, electronic mailing and internet browsing applications.

The station 100 may further comprise a user interface 220, which in the station of FIGS. 1a and 1b is comprised of the display 120 and the keys 130, 135.

The station 100 further comprises a radio frequency interface 230, which is adapted to allow the station to communicate with other devices via a radio frequency band through the use of different radio frequency technologies. Examples of such technologies are IEEE 802.11, IEEE 802.11 Mesh and Bluetooth® to name a few. Other examples of radio technologies for example for communicating with devices outside the mesh network that may be implemented in a station 100 are W-CDMA, GSM, UTRAN, LTE, NMT to name a few.

FIG. 3 shows a mesh network 300. A mesh network 300 comprises a plurality of nodes which may be a station 100 as in FIGS. 1a, 1b and 2. The mesh network 300 may also comprise at least one access point 330, referred to as a Mesh Access Point (MAP). A network without any access points 330 is called an ad hoc network. A MAP 330 is also an example of a network node. In a mesh network 300 each node 330, 100 is configured to capture and disseminate data that is aimed for the specific node. Each node 330, 100 is also configured to serve as a relay for other nodes 100, that is, the node 100 must collaborate to propagate data in the network 300. The mesh access points 330 are configured to serve as relays and routers for the other nodes 100. The nodes 330, 100 are configured to connect to one another through links or connections 350.

The network shown in FIG. 3 is a wireless mesh network and the stations 100 and the access points 330 (if any) are configured to establish the wireless links 350 for communicating with one another.

In this example, the mesh network is arranged to operate according to the IEEE 802.11 Mesh standard. There are three types of nodes 330, 100 in such a mesh network, namely Mesh Points (MP), Mesh Portal Points (MPP) and Mesh Access Points (MAP).

An MP is often a laptop, smartphone or other wireless device, such as has been disclosed in the above with reference to FIGS. 1a and 1b.

The MPs support a protocol for communicating with other nodes, nodes that are not necessarily neighbors to the MP. In IEEE 802.11 Mesh this protocol is called Hybrid Wireless Mesh Protocol (HWMP). It is hybrid because it supports two kinds of path selection protocols. In IEEE 802.11 Mesh the protocols use the MAC addresses for addressing a data package correctly. Each node 330, 100 is configured to find a path from one node 330, 100 to another node 330, 100. This is referred to as path selection.

An MPP is configured to provide gateway functionality to the mesh network. The MPP may for example be a portal to the internet 320 or a communication network 310, such as a mobile telecommunications network. An MPP must thus be configured to bridge at least two interface protocols. An MPP is often a laptop, a cell phone or other wireless device.

A MAP is an access point that is configured to also communicate according to the mesh network standard and to operate as an access point.

In the mesh network 300 of FIG. 3 there are eight nodes 330, 100 whereof three are laptops, three are smartphones and two are routers. Two nodes are MAPs, three nodes are MPs and at least two nodes are MPPs. It should be noted that a node may have the capability to act as both an MP and an MPP. For example, the MPs of the example mesh network of FIG. 3 may actually also be MPPs. For clarity issues, only three nodes are illustrated as having internet capability and three as having capabilities for mobile telecommunication.

A mesh network can be designed using a flooding technique or a routing technique. When using a routing technique, a message propagates from a sending node 100 to receiving node 100 along a path, by hopping from node 100 to node 100 until the receiving node 100 is reached. To ensure that all paths are available, a routing network must allow for continuous connections and reconfiguration around broken or blocked paths, using self-healing algorithms. According to the standard IEEE 802.11 Mesh should a path be broken this will be discovered after a time period (e.g. 5 s) when a sending node detects that reception is not acknowledged. The system then performs a rerouting procedure by sending out path requests (PREQ).

The self-healing capability enables a routing-based network to operate when one node breaks down or a connection goes bad. As a result, the network is typically quite reliable, as there is often more than one path between a source and a destination in the network. Although mostly used in wireless scenarios, this concept is also applicable to wired networks and software interaction.

A wireless mesh network (WMN) is a communications network made up of radio nodes (laptops, cell phones and other wireless devices) while the mesh routers forward traffic to and from the gateways which may but need not connect to the Internet. The coverage area of the radio nodes working as a single network is sometimes called a mesh cloud. Access to this mesh cloud is dependent on the radio nodes working in harmony with each other to create a radio network. A mesh network is reliable and offers redundancy. When one node can no longer operate, the rest of the nodes can still communicate with each other, directly or through one or more intermediate nodes. Wireless mesh networks can be implemented with various wireless technology including 802.11, 802.15, 802.16, cellular technologies or combinations of more than one type.

A wireless mesh network often has a more planned configuration, and may be deployed to provide dynamic and cost effective connectivity over a certain geographic area. An ad-hoc network, on the other hand, is formed ad hoc when wireless devices come within communication range of each other. The MAPs may be mobile, and be moved according to specific demands arising in the network. Often the MAPs are not limited in terms of resources compared to other nodes in the network and thus can be exploited to perform more resource intensive functions. In this way, the wireless mesh network differs from an ad-hoc network, since these nodes are often constrained by resources.

Prior art mesh networks are created according to the Wi-Fi IEEE 802.11 Mesh protocol. The Mesh protocol handles such things as neighbor peering establishment, mesh path selection and data forwarding between different wireless mesh stations. IEEE 802.11 Mesh also defines a power mode that tracks peer mesh station beacons to aid in synchronization and communication.

According to IEEE 802.11 Mesh, every station within the mesh network may broadcast mesh beacons in order to discover new peers and establish peer connections. The power consumption of the mesh network thus increases linearly to the number of peered mesh stations.

In order to reduce power, IEEE 802, 11 Mesh Power Save Mode dictates that stations may enter an idle mode wherein they do not transmit mesh beacons. However, since there is no way to keep track on when the stations within the mesh network are in idle mode or in awake mode, the mesh network may suffer latency problems due to lack of local synchronization between peers.

The inventors have realized after insightful reasoning that the power consumption within a mesh network may be greatly reduced if a new protocol is introduced which enables a discovery window (DW), a mesh management window (MMW) and a plurality of mesh awake windows (MAWs) forming a MAW map while also removing the 802.11 Mesh Peering protocol and 802.11 Mesh Power Save mode from mesh devices. A new Mesh Power Save mode is introduced which follows the local MAW map.

By removing the 802.11 Mesh Peer protocol the mesh stations are no longer enabled to transmit mesh beacons in order to establish peer connections. The stations are also not enabled to become idle in an unsynchronized manner since the 802.11 Mesh Power Save Mode is disabled.

Instead, the new protocol functions as a synchronizing protocol for the stations within the mesh. The protocol configures the stations to be awake and listen to a predetermined channel, e.g. channel 6, during the duration of the DW. In some embodiments, the duration of the DW is 16 TU (Time Units), e.g. 16*1024 μs. During the DW the stations may listen for a discovery beacon which discovers new peers entering the mesh network.

In some embodiments, the DW may be a NAN (neighbor awareness network) discovery window.

The NAN protocol enables neighbor discovery, service discovery and network synchronization. A node in a NAN network may comprise three states, a master state, a non-sync master state, and a non-master non-sync state. A master node (i.e. a node being in the master state) may transmit discovery beacon and a synchronization beacon. A non-master sync node may transmit a synchronization beacon. A non-master non-sync node may only listen for beacons and may not it self transmit the beacons.

The nodes within the NAN may change between the states. It is e.g. likely that a node having several neighbors will transit into the non-master non-sync state as it is likely that there is at least one other master node or at least one other non-master sync node within the vicinity. In the same way, a node having few neighbors may transit into the master state.

A node being in the master state is configured to transmit a discovery beacon for neighbor discovery and a synchronization beacon for network synchronization.

In some embodiments, the stations within the mesh network may be configured to comprise a master state, a slave sync state, and a slave state. The master state enables a station to transmit discovery beacons and synchronization beacons. The slave sync state enables a station to transmit synchronization beacons and disable the station's ability to transmit a discovery beacon. The slave state disables a station's ability to transmit any beacons.

In some embodiments, the stations within the mesh network may be configured to comprise states according to the NAN protocol.

In some embodiments, a first station, e.g. a NAN master node transmits the discovery beacon outside the DW on e.g. channel 6. A vendor specific attribute is encapsulated within the discovery beacon so that any unsynchronized stations may gain knowledge of the existence of the mesh network.

The first station may also transmit a synchronization beacon during the DW. The synchronization beacon synchronizes the timing within the mesh network. This results in that all stations within the network are synchronized in relation to the first station transmitting the synchronization beacon.

A synchronization beacon may also be transmitted by one or more other stations within the network, e.g. one or more NAN non-master sync nodes.

Since not all stations within the mesh network are configured to transmit the synchronization beacon (i.e. unless they are authorized to do so, such as if they transit into a master state, e.g. a NAN master state or a NAN non-master sync state), the average power consumption within the mesh is lowered. The risk of congesting the network due to an abundance of beacons is also lowered.

After the DW, there follows a MMW during which all stations within the mesh network are configured to be awake and listen to a specific channel, e.g. channel 6. The synchronization beacon is in some embodiments used to synchronize the stations within the mesh network so that all stations within the mesh network are awake during the duration of the MMW.

The MMW is used for transmitting HWMP (Hybrid Wireless Mesh Protocol) frames such as PREQ and PREP frames and service frames. The stations are thus configured to at least be awake during the DW and MMW and to transmit HWMP frames during the MMW.

In some embodiments, Multicast/broadcast data frames and management frames are also transmitted during the MMW.

In the Mesh Peering Protocol, information elements (IE) such as supported rates IE, extended rates IE, etc. are used for peering. Since the Mesh Peering Protocol is removed, the IEs are instead incorporated the HWMP management packets such as PREP/PREQ, HWMP (Hybrid Wireless Mesh Protocol) frames such as PREQ and PREP frames and service frames. The stations are thus configured to at least be awake during the DW and MMW and to transmit HWMP frames during the MMW.

In some embodiments, a number of MAWs are embedded within the HWMP frames, where the number of MAWs represent windows (wherein a window comprises a number of available bits) available for communication and define a MAW map, or MAW bitmap. In some embodiments, the number of MAWs may be limited by the DW and MMW period cycle. If the Period cycle is 512 TU, and the DW, MMW and each MAW is 16 TU, then the maximum number of MAWs is 30.

The MAW map dictates to a station which MAWs may be used for a communication between the station and one or more other stations.

The discovery window DW, the Mesh Management Window MMW and the Mesh Awake Windows MAWs may be transmitted during a periodic cycle of 512 TU., wherein the DW and MMW comprise 16 TU each and the MAWs may be utilized during the remaining time.

Stations that are not involved in communication with other peers are awake during the DW and the MMW, but may be in idle or sleep mode during the rest of the cycle.

A station that is in idle or sleep mode does not transmit any communication, nor does it listen to any surrounding communication within the network. The station in idle or sleep mode cannot be contacted by other peers until it is awake again.

Communication within the mesh network may take place on a plurality of different communication channels, or channels, comprising separate frequency ranges. In some embodiments, all stations within the mesh network are configured to be awake and listen to a predetermined channel, e.g. channel 6, during the duration of he DW and the MMW. However, the stations may not be aware of the situations of the other channels within the mesh. E.g. a station transmitting on one channel which is close to be being congested, or trying to transit on a channel that is congested, may not be aware that there are other communication channels within the mesh that are free of congestion and would be more suitable to house the communication.

The inventors have realized after insightful reasoning that this problem may be overcome by introducing a MAW map for each communication channel.

According to some embodiments, a first station, whom whishes to communicate with a second station, may create a MAW map for each communication channel within the mesh network. The MAW map for each channel indicates which slots, or MAWs, are available for communication on the specific channel. If a channel is too congested, i.e. too many of the available MAWs of the MAW map are indicated as congested leading to that the desired communication cannot be supported, the entire MAW map may be removed from that particular channel.

FIGS. 4, 5, 6 and 7 illustrates a method according to some embodiments of how communication within the mesh may be carried out.

In FIG. 4 a first station, e.g. any of the stations 100 described in FIGS. 1, 2, and 3, whishes to communicate with a second station, e.g. any of the stations 100 in FIGS. 1, 2 and 3, within a mesh network, e.g. the mesh network in FIG. 3.

According to the method 400, the first station begins with defining 401 a quality of service (QoS) class which may comprise a communication type and a desired level of quality of the communication. The communication type may e.g. voice communication, transmission of service data packets, and/or transmission of communication data packets. The desired level of quality may e.g. be that no packets may be dropped, that no more than a ratio of packages is dropped, that all packets should be received in a certain order, or that all packets should be received within a maximum latency, and minimum jitter etc.

Based on the QoS class the first station assesses how many MAWs are needed for the communication, and which communication channels are available. The first station may determine this based on information comprised in the MMW or based on information pertaining to current ongoing traffic (or communications) through the station.

The first station then sets 402 the available MAWs to 1 for each available communication channel.

The first station may determine 405 if the available MAWs and the available communication channels are sufficient to support the communication according to the QoS.

If the first station determines that the available channels and the available MAWs pertaining to the available channels are sufficient to support the communication according to the QoS class (“Yes” path out of 405), then the first station may define 407 a MAW map for each available communication channel comprising the available MAWs for that particular communication channel.

The first station then embeds the MAW maps pertaining to the available communication channels within a path request (PREQ) frame addressed to a second station, the second station may e.g. be any of the stations 100 in FIGS. 1, 2, and 3, which PREQ is broadcasted 408 during the MMW to the neighboring stations within the mesh network.

If the first station determines that the available MAWs pertaining to the available channels aren't sufficient to support the communication according to the QoS class (“No” path out of 405) then the first station may refrain from creating the MAW maps, and instead wait 406 one MMW cycle before trying to set 402 available MAWs and available channels based on the QoS class.

Since mesh networks are dynamic with an ever changing topology due to stations entering and leaving the network, it is likely that the resources on each communication channel have been redistributed and that channels that were congested during the first MMW will not be congested during the next MMW.

The PREQs and PREPs transmitted during the MMW may also carry information pertaining to estimated life time of a communication. Thus the first station taking part of the PREQs and PREPs may during the MMW asses that a certain channel will be occupied for a certain time, and may hence decide not to include it at all in its own PREQ.

Furthermore, if the first station is aware of that one or more of the MAWs of the MAW map pertaining to each available communication channel are congested, the first station may remove the congested MAWs from the MAW map, thus ensuring that a congested MAW is not encumbered further. A congested MAW may be detected through monitoring actual dataflow, size of queued data, or marking of used MAWs indicated by overheard MAW maps during an MMW period.

Transmitting the PREQ during the MMW ensures that all neighboring stations within the mesh network will receive it as they are configured to be awake and listen for HWMP and service frames during each MMW.

The PREQ comprising the MAW maps for each available channel is typically transmitted using multihop from the first station to the second station through one or more intermediate stations. Each station receiving the PREQ may indicate in the MAW maps pertaining to each available communication channel which slots are available for communication by removing MAWs from the MAW map that are congested. When the second station receives the PREQ it may determine, based on the QoS class, which MAWs out of the remaining available MAWs and hence which channels of the available channels that should be used for the communication and indicate this in a final MAW map. The final MAW map is then embedded in a PREP and transmitted back to the first station.

The first station then checks 409 if it has received the PREP frame comprising the final MAW map from the second station.

If the first station has received the PREP comprising the final MAW map (“Yes” path out of 403) it will commence transmission 410 of the communication on the MAWs of the available channels as indicated by the final MAW map to the second station.

If the PREP has not been received (“No” path out of 409) the first station determines 411 if a time period for reception of the PREP has expired.

The time period for reception of the PREP may be dynamically set by the station based on network parameter such as size of the network, amount of network resources, geographical area, mobility parameters etc. The time period for reception of the PREP may in some embodiments be 1 cycle of MMWs, e.g. if the mesh is small with few stations the response time of the second station should be short. In some embodiments, the time period for reception of the PREP is more than 5 cycles, e.g. a larger mesh may require longer response time. However, it is to be understood that other number of cycles are possible.

If the first station determines that the time period for receiving the PREP has expired (“Yes” path out of 409) then the first station may wait 1 or more cycles before restarting the method 400 by defining a QoS class 401 and setting 402 all available MAWs of the available channels to one.

If the first station determines that the time period for receiving the PREP has not expired (“No” path out if 409) then the first station again checks if it has received 409 the PREP comprising the final MAW map.

As elaborated on above, the PREQ frame may hop through one or more intermediate station before reaching the second station.

FIG. 5 illustrates a method for an intermediate station according to some embodiments.

The method 500 starts with the intermediate station (e.g. any of the stations 100 in FIGS. 1, 2, and 3) receiving 501 a PREQ frame from a first station (e.g. any of the station 100 as in FIGS. 1, 2, and 3 carrying out the method 400 described in FIG. 4) addressed to a second station (e.g. any of the station 100 as described in FIGS. 1, 2 and 3).

The PREQ frame comprises a MAW map indicating available MAWs for one or more available communication channels on which the communication between the first station and the second station may take place and a QoS class defining what type the communication is of and of what level of quality the communication needs to be (compare with method 400 in FIG. 4).

The intermediate station may determine if it is able to support the communication type and the desired level of quality by assessing its own resources. E.g. the intermediate station may be involved in too many other communications for it to be able to support a new communication between to first station and the second station, low battery of the mesh station may be another indicator if the intermediate station is able to support the communication or not.

If the intermediate station determines that it cannot support the QoS class then the intermediate station may directly discard the PREQ and not transmit it further.

If the intermediate station determines that it can support the QoS class, then the method 500 may continue with that the intermediate station determines if one or more of MAWs pertaining to the communication channels according to the MAW map are available for the communication according to the QoS class. The intermediate station may indicate in the MAW maps pertaining to each available communication channel, which of the MAWs are available for transmission by removing MAWs from the MAW map that are not available. The intermediate station may e.g. already be involved in a communication with another station within the mesh, wherein the communication takes place on certain MAWs and demands a lot of resources. The intermediate station may thus decide to remove these MAWs from the MAW map from the first station.

The intermediate station may thus determine if any of the available channels are congested. If the intermediate station detects that several MAWs within a MAW map pertaining to an available channel are congested, then the intermediate station may determine that the channel itself is too congested and will not be able to support the communication according to the QoS class. The intermediate station may then remove 503 the entire MAW map pertaining to the congested channel, which MAW map and channel will not be transferred further by the intermediate station.

If the intermediate station determines that there is no congestion on the available channels as indicated by the MAW map the intermediate station determines 504 if the available MAWs on the available channels are sufficient to transmit the communication according to the QoS class. If the intermediate station determines that the available MAWs on the available channels are not sufficient to transmit the communication according to the QoS class (“No” path out of 504), then the intermediate station discards 505 the PREQ.

If the intermediate station determines that the available MAWs on the available channels are sufficient to transmit the communication according to the QoS class, then the intermediate station forwards 506 the PREQ comprising the altered, or unaltered, MAW maps for each available channel.

The PREQ is then transmitted forward either to one or more intermediate stations (e.g. any of the stations 100 in FIGS. 1, 2 and 3), which intermediate stations repeats the method 500 until the PREP arrives at the second station.

As elaborated on above, if the intermediate station determines that it cannot support the communication according to the QoS class, it discards the PREQ. Since the PREQ is broadcasted, the likelihood that the PREQ will find its way to the second station through another intermediate station is still high.

If for some reason, e.g. the network is entirely congested, non of the neighboring peers are able to support the communication resulting in that all of them discards the PREQ, then the first station will wait, e.g. during one or more cycle, before broadcasting a new PREQ comprising a MAW map (compare method 400 if FIG. 4).

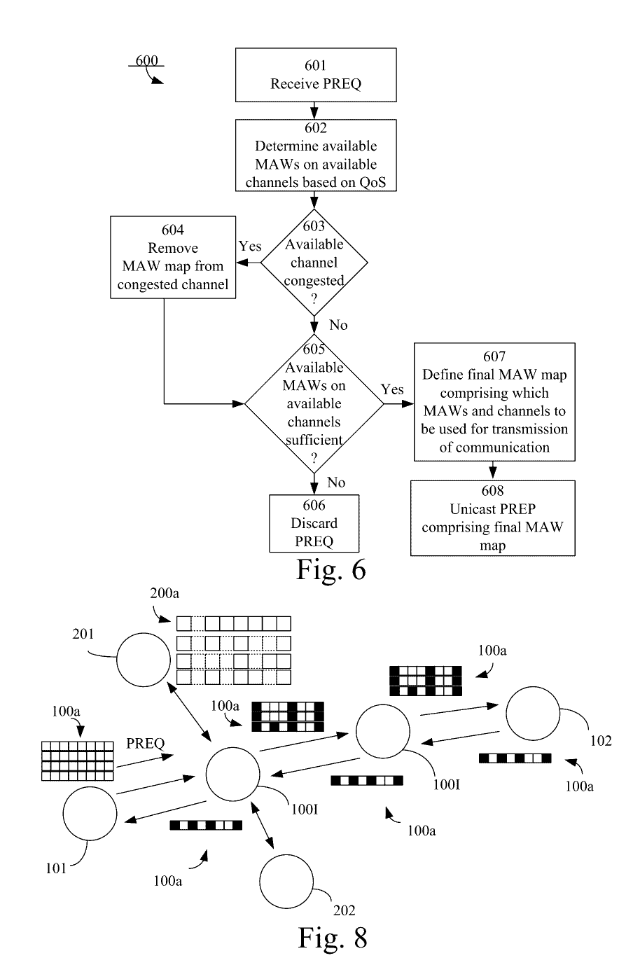

FIG. 6 illustrates a method 600 for the second station (e.g. any of the station 100 in FIGS. 1, 2 and 3) according to some embodiments.

The second station receives 601 a PREQ frame from a first station (e.g. the PREQ frame sent by the first station described in the method 400 in FIG. 4, or the PREQ sent by the intermediate station described in the method 500 in FIG. 5) comprising a MAW map and a QoS class (compare with the method 400 and 500).

The second station determines 602 which of the available MAWs on each available communication channel according to the MAW maps for each communication channel are available by removing congested MAWs from the MAW maps (compare with method 500). Based on the available MAWs in the MAW map for each available channel the second station determines if any of the available communication channels are too congested to support the communication according to the QoS class. If the second station determines that one or more of the available channels are congested (“Yes” path out of 603) then the second station removes 604 the entire MAW map of the congested channel. The removed MAW map ensures that no traffic is transmitted on the congested channel, thus encumbering it further.

When the second station has determined if one or more of the available channels are congested, or if it is determined that none of the available channels are congested (“No” path out of 603) then the second station determines 605 if the remaining MAWs of the MAW maps pertaining to the remaining available channels are sufficient for transmitting the communication according to the QoS class. If the second station determines that the MAW maps pertaining to the remaining channels are not sufficient (“No” path out of 605), then the second station discards 606 the PREQ.

If the second station determines that the remaining MAW maps pertaining to the remaining available channels are sufficient for transmitting the communication according to the QoS (“Yes” path out of 605), then the second station defines 607 a final MAW map comprising on which available channels, using which available MAWs, the communication should be transmitted on.

The second station the embeds the final MAW map in a path reply (PREP) frame to the first station and transmit by unicast 608 the PREP frame comprising the final MAW map through the one or more intermediate stations to the first station.

The final MAW map dictates the channel and MAWs the communication will take place on. E.g. the final MAW map will contain the channel and MAWs that all stations in the path towards the first station decided as not congested and may be used for communication between first and second station.

As elaborated on above, if the second station determines that it cannot support the communication according to the QoS class, it will discard the PREQ. The first station will detect after a while (compare method 400) that a PREP pertaining to the PREQ has not returned.

The first station may then wait, e.g. during one or more cycles, before broadcasting a new PREQ comprising the MAW map. Since mesh networks are highly dynamic, the chance of the second station being able to accommodate the communication at a slightly later point in time is therefore high.

In some embodiments, mesh paths are defined in the mesh network (e.g. the mesh network in FIG. 3) when a first station has established a connection with a second station through zero or more intermediate stations (the first, second and intermediate stations may e.g. be any of the station as described in conjunction with FIGS. 1, 2, 3, 4, 5 and 6). The mesh path comprises all the stations that are involved in the communication between the first and the second station, i.e. the first station, the second station and the zero or more intermediate stations that are needed to forward the communication from the first station to the second station.

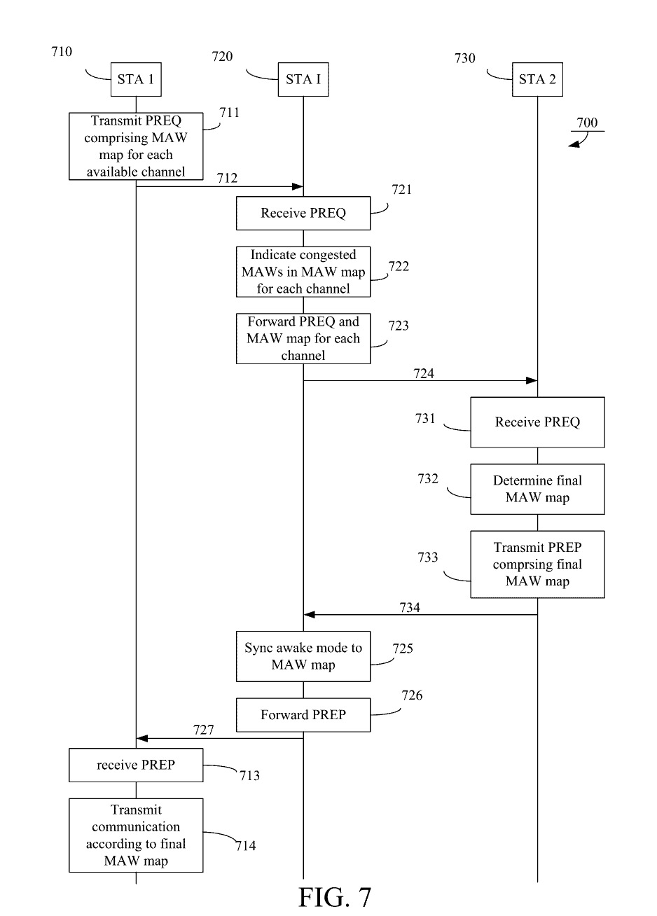

FIG. 7 illustrates a method 700 according to some embodiments for setting up the active path between a first station (STA 1), an intermediate station (STA I) and a second station (STA 2). In some embodiments, the first station may e.g. be any of the station 100 as described in FIGS. 1, 2, and 3 and/or the first station as described in FIGS. 4, 5 and 6. In some embodiments, the intermediate station may e.g. be any of the stations 100 as described in FIGS. 1, 2 and 3 and/or the intermediate station as described in FIGS. 5, 4 and 6. In some embodiments, the second station may e.g. be any of the station 100 in FIGS. 1, 2 and 3 and/or the second station as described in FIGS. 6, 4 and 5.

The first station initiates the communication by defining a QoS class (compare with method 400 in FIG. 4) defining a communication type and a desired level of quality of the communication. Then the first station indicates in a MAW map for each available communication channel comprising a plurality of MAWs which MAWs are available for communication by setting the available MAWs to 1 and embeds the MAW maps and QoS class in a PREQ addressed to the second station.

The first station then broadcasts 711 the PREQ during a MMW. Since all stations within the MESH are configured to be awake during the MMW and listen for HWMP frames such as PREQS and PREPS it is guaranteed that neighboring stations will receive the broadcast.

The intermediate station receives 721 the broadcasted PREQ (through signaling arrow 712 either directly from the first station or from another intermediate station).

The intermediate station determines if it can support the QoS class and removes 721 any congested MAWs from the MAW map (compare method 500 in FIG. 5). If any MAWs are congested they are removed from the MAW map before the PREQ is forwarded 723 to the second station (signaling arrow 724). If a MAW map of an available channel indicates that the channel is congested (compare with method 500 or 600) the entire MAW map for that channel is removed.

The second station receives 731 the PREQ with the MAW maps for each available channel and QoS class and determines 723 a final MAW map based on the appearance of the received MAW maps, i.e. available channels, congested MAWs and the QoS class (compare method 600 in FIG. 6).

The final MAW map is then embedded in a PREP and transmitted 733 back to the first station through the intermediate station (signaling arrow 734).

The intermediate station upon receiving the PREP checks which MAWs and which channel it shall use for the communication between the first and the second station and syncs 725 itself so that is awake during the duration of the communication between the first and the second station. The intermediate station then forwards 726 the PREP to the first station (signaling arrow 727).

The first station receives the PREP 713 and initiates transmission of the communication to the second station using the MAWs and the channels according to the final MAW map.

In some embodiments, the method 700 may combined with one or more of the methods 400, 500 and 600.

As elaborated on above, the first station, second station and (zero or more) intermediate station defines a mesh path for their communication transmission. All stations along the mesh path will be synchronized to transit on the MAWs and channels as indicated by the final MAW map and thus be awake at the same time. Latency and congestion is decreased within the network since the stations are synchronized to be awake at the same time and since they may avoid using congested MAWs and channels, thus avoiding encumbering them further.

In some embodiments, each MAW map pertaining to a communication channel may have at least one MAW reserved for voice traffic in a specific channel, e.g. channel 6. Thus real time traffic, e.g. voice communication has always guaranteed bandwidth even when all other MAWs are congested. Also real time traffic have the highest possibility of succeeding to establish a path due to all stations in the network reserving the specific MAWs and channel for real time traffic only.

FIG. 8 illustrates a mesh network scenario according to some embodiments.

The stations 101, 100I and 102 define a mesh path on the way to be set up (e.g. by using any of the methods 400, 500, 600 or 700). The stations 201, 100I and 202 define an already mesh path where the station 201 communicates through the station 100I with the station 202.

In some embodiments, the station 101 may e.g. be the stations 100 described in FIGS. 1, 2 and 3 and/or the first station as described in any of the FIGS. 4, 5, 6 and 7.

In some embodiments, the station 100I may be any of the stations 100 in FIGS. 1, 2 and 3 and/or any of the intermediate station in FIGS. 4, 5, 6 and 7.

In some embodiments, the station 102 may be any of the stations 100 in FIGS. 1, 2 and 3 and/or the intermediate station in FIGS. 4, 5, 6 and 7.

In some embodiments, the station 201 may e.g. be the stations 100 described in FIGS. 1, 2 and 3 and/or the first station as described in any of the FIGS. 4, 5, 6 and 7.

In some embodiments, the station 202 may be any of the stations 100 in FIGS. 1, 2 and 3 and/or the intermediate station in FIGS. 4, 5, 6 and 7.

The station 101 broadcasts a PREQ comprising a MAW map 100a for each available communication channel indicating available MAWs during a MMW (compare method 400 and 700).

The PREQ is received by the station 100I which is already transmitting communication from the station 201 to the station 202. The station 100I knows that the MAWs in the MAW map 200a of each available communication channel pertaining to the communication between the station 201 and the station 202 which are indicated by the dotted edges in FIG. 8 are available for communication. The station 100I may determine that some of the MAWs that are already used by the MAW map 200a may also be used for the communication between the station 101 and 102 and indicates these MAWs as available in the MAW map 100a.

However, the station 100I is also aware of that one of the communication channels is congested as indicated by the occupied MAWs in the MAW map 200a compare with method 500 and 700). The station 100I can therefore not use these MAWs in order to forward the communication from the station 101 to the station 102 and indicates this by removing the entire MAW map pertaining to congested channel. The station 100I may also determine that some of the MAWs of MAW maps of the remaining available channels are too occupied and cannot be used for the communication between the station 101 and the station 102. The station 100I may indicate this by removing the congested MAWs from the MAW map (as indicated by the dark MAWs in the MAW map 100a).

The station 100I then embeds the altered MAW map pertaining to the remaining available communication channels in the PREQ again and forwards it by broadcast to the next intermediate station 100I during the MMW.

The next intermediate station 100I is not involved in any other communication and does not experience any congestion on any of the available MAWs of the MAW maps for each available channel and therefore forwards the received PREQ with the MAW map 100a unaltered to the station 102.

The station 102 receives the PREQ comprising the MAW map 100a for each available communication channel and determines based on the QoS class which MAWs of the MAW map 100a and communication channel should be used for the communication. In some embodiments, the station 102 determines that one or more of the MAWs are congested and removes the congested MAWs from the MAW map 100a. The station 102 may also determine that one of the available communication channels are not suitable to transmit the communication according to the QoS class, and removes the MAW map pertaining to that channel.

The station 102 then determines if the altered MAW maps pertaining to the available communication channels are sufficient for transmitting the communication and if so, determines the appearance of the final MAW map 100a by determining which of the available communication channels should be used and including the available channel in the MAW map 100a prior to embedding the final MAW map in a PREP frame (compare with methods 600 and 700).

The station 102 then transmits the PREP to the next station 100I which syncs its wakeup pattern to the communication according to the final MAW map prior to transmitting the PREP to the station 100I. The station 100I syncs its wake up pattern to the communication according to the final MAW map. Then the station 100I transmits the PREP to the station 101 which commences transmission of the communication to the station 102 along the now established mesh path through the stations 100I on the MAWs and the channel according to the final MAW map 100a.

In some embodiments, the stations 101, 100I, 102, 201 and 202 may use the methods described in FIGS. 4, 5, 6 and 7 in order to establish and synchronize a mesh path.

In some embodiments, each MAW is designed to be sufficiently long to support end to end communication for a predetermined number of hops, e.g. 16TU for 6 hops.

This enables a station to estimate how long the communication will be and how many packets may be sent during each MAW to ensure that they reach their destination.

Packets that are not transmitted within a MAW are queued or aggregated for the next upcoming MAW.

This results in that packet aggregation occurs naturally when packets are queued for the upcoming MAW. It also helps throughput within the mesh network since it is ensured that frames will be transmitted on the dedicated available MAWs. And the stations within a mesh path will be aware for how long a certain MAW will be occupied according to the MAW map.

The concept also introduces the life time of the communication into HWMP PREQ/PREP frames. By introducing an extra field in the header of the PREQ/PREP frames which keeps track on the life time of the communication.

The life time of the communication may be dictated by the MAW cycles, and an estimated time for transmission. The remaining life time of communication may be continuously communicated with each HWMP path refresh.

The introduction of the DW, the MMW and the MAWs makes it possible to remove the Mesh beacon for discovering peers, which greatly reduces power consumption within the mesh network. Because of the DW and MMW, all stations are configured to be awake at the same time and to listen to the same channel which ensures that new stations entering the network listen to the same channel and will therefore be found when they are wanted for communication. It also ensures that existing stations and new stations will find peers which they wish to speak to.

The mesh paths also enables that stations only need to keep track on the stations within the mesh path, and not all the other peers. This since stations will be able to reach other peers when needed through the HWMP frames transmitted through the MMW.

The MAWs help mitigate the risk of congestions since the stations may deliberately choose not to transmit on a congested MAW. A station is enabled to pass up a communication it does not have resources to support which in the long run will enhance throughout in the mesh. By rejecting communication when the station determines that it does not have enough resources, or is too congested, the station will not further congest itself. Instead, the communication within the mesh is evenly distributed between stations having enough capacity.

The concept greatly reduces power consumption within the mesh network, mitigates the risk of congestion and decreases latency which increases overall throughput of the mesh network.

Reference has been made herein to various embodiments. However, a person skilled in the art would recognize numerous variations to the described embodiments that would still fall within the scope of the claims. For example, the method embodiments described herein describes example methods through method steps being performed in a certain order. However, it is recognized that these sequences of events may take place in another order without departing from the scope of the claims. Furthermore, some method steps may be performed in parallel even though they have been described as being performed in sequence.

In the same manner, it should be noted that in the description of embodiments, the partition of functional blocks into particular units is by no means limiting. Contrarily, these partitions are merely examples. Functional blocks described herein as one unit may be split into two or more units. In the same manner, functional blocks that are described herein as being implemented as two or more units may be implemented as a single unit without departing from the scope of the claims.

Hence, it should be understood that the details of the described embodiments are merely for illustrative purpose and by no means limiting. Instead, all variations that fall within the range of the claims are intended to be embraced therein.

1. A method for a mesh network comprising a first station, a second station and one or more intermediate stations, wherein communication within the mesh network is transmitted on a plurality of communication channels, wherein the method comprises:
initiating a communication by the first station with the second station of the mesh network, wherein the first station, the second station and the one or more intermediate stations define an mesh path for the communication;
defining by the first station a quality of service—QoS—class indicating a desired level of quality of the communication;
determining available communication channels out of the plurality of communication channels based on the QoS;
setting by the first station a limited number of mesh awake windows—MAW—as available for each available communication channel based on the QoS class;
defining a MAW map comprising the available MAWs for each available communication channel;
embedding by the first station the QoS class and the MAW maps in the PREQ frame; and
broadcasting, by the first station, a path request—PREQ—frame comprising the QoS class and the MAW maps to the second station during a Mesh Management Window—MMW.

2. The method according to claim 1, wherein the QoS class further defines a communication type being at least one of a voice communication, transmission of service data packets, and/or transmission of communication data packets.

3. The method according to claim 2, wherein at least one MAW of each MAW map pertaining to the available communication channels is reserved for voice communication.

4. The method according to claim 3, further comprising each of the one or more intermediate stations along the mesh path upon receiving the PREQ:
indicating in the MAW map of each available communication channel which MAWs are available for the communication based on the QoS class and removes congested MAWs from the MAW map of each available communication channel;
determining if the MAW map for each available communication channel is sufficient to transmit the communication based on the QoS class; and
if it is determined that the MAW map for each available communication channel is not sufficient to transmit the communication based on QoS, thus indicating an unavailable channel, discarding the PREQ; or
if it is determined that the MAW map for each available communication channel is sufficient to transmit the communication based on QoS, thus indicating an available channel:
broadcasting the PREQ comprising the MAW map for each available communication channel.

5. The method according to claim 4, further comprising the second station upon receiving the PREQ comprising the MAW map for each available communication channel
Determining which one or more of the available communication channels and which MAWs in the MAW maps pertaining to the one or more of the available communication channels should be used for the communication based on the available communication channels, QoS class and indicated available MAWs by defining a final MAW map comprising the one or more available communication channel and the MAWs to be used for the communication and
transmitting a path reply—PREP—frame comprising the final MAW map to the first station or
discarding the PREQ if it is determined that no of the one or more available communication channels or the MAWs should be used for the communication.

6. The method according to claim 5, further comprising:
receiving by the first station the PREP frame from the second station, wherein the PREP frame comprises the final MAW map; and
transmitting by the first station the communication on the available MAWs of the final MAW map along the mesh path; or
transmitting, by the first station, a new PREQ and a new MAW map if the second station determines that no MAWs of the MAW map should be used for communication.

7. A network station, comprising a controller, wherein the network station is configured to operate as a first station in a mesh network comprising a second station and one or more intermediate stations wherein communication within the mesh network is transmitted on a plurality of communication channels;
wherein the first station is configured to initiate communication with the second station of the mesh network, wherein the first station is configured to define a mesh path for communication in cooperation with the second station and the one or more intermediate stations;
wherein the first station is configured to define a quality of service—QoS—class indicating a desired level of quality of the communication type;
wherein the first station is configured to set one or more of the plurality of communication channels as available based on the QoS class;
wherein the first station is configured to set a limited number of mesh awake windows—MAW—as available for each available communication channel based on the QoS class;
wherein the first station is configured to define a MAW map for each available communication channel comprising the available MAWs;
wherein the first station is configured to embed the QoS class and the MAW maps for each available communication channel in a path request—PREQ—frame; and
wherein the first station is configured to broadcast the PREQ frame comprising the QoS class and the MAW maps for each available communication channel to the second station during a Mesh Management Window—MMW.

8. A method for a station being a first station in a mesh network comprising a second station and one or more intermediate stations wherein communication within the mesh network is transmitted on a plurality of communication channels; the method comprising:
initiating a communication by the first station with the second station of the mesh network, wherein the first station, the second station and the one or more intermediate stations define an mesh path for the communication;
defining a quality of service—QoS—class indicating a desired level of quality of the communication;
setting one or more of the plurality of communication channels as available based on the QoS class;
setting a limited number of mesh awake windows—MAW—as available for each available communication channel based on the QoS class;
defining a MAW map for each available communication channel comprising the available MAWs;
embedding the QoS class and the MAW map for each available communication channel in the PREQ frame; and
broadcasting the at least one PREQ frame comprising the QoS class and the MAW map to the second station during a Mesh Management Window—MMW.

9. The method according to claim 8, wherein the first station is further configured to, prior to defining the MAW map for each available communication channel,
determine if the available communication channels comprising the available MAWs are sufficient for transmitting the communication based on the QoS class; and if it is determines that the available communication channels comprising the available MAWs are not sufficient for transmitting the communication based on the QoS class,
wait for a next MMW before creating the MAW map.

10. A network station comprising a controller, the network station being configured to operate as an intermediate station in a mesh network comprising a first station and a second station wherein communication within the mesh network is transmitted on a plurality of communication channels;
wherein the intermediate station is configured to receive a path request—PREQ—frame from the first station in the mesh network to the second station in the mesh network for initiating a communication between the first and second station, wherein the PREQ frame comprises a limited number of mesh awake windows—MAWs—defining a MAW map for each available communication channel and a quality of service—QoS—class indicating a desired level of quality of the communication;
wherein the intermediate station is configured to indicate MAWs available for the communication in the MAW map for each available communication channel based on the QoS class and remove congested MAWs from the MAW map for each available communication channel;
wherein the intermediate station is configured to remove the entire MAW map pertaining to an available channel if too many of the available MAWs are congested based on the QoS class; and
wherein the intermediate station is configured to determine if the MAW map for each available communication channel is sufficient for transmitting the communication in relation to the QoS class;
wherein the intermediate station is configured forward the PREQ comprising the MAW maps for each available communication channel to the second station if it is determined that the MAW maps for each available channel is sufficient for transmitting the communication in relation to the QoS class, or to discard the PREQ if it is determined that the MAW maps for each available channel is not sufficient for transmitting the communication in relation to the QoS class.

11. A method for a network station being an intermediate station in a mesh network comprising a first station and a second station wherein communication within the mesh network is transmitted on a plurality of communication channels; wherein the method comprises
receiving a path request—PREQ—frame from the first station in the mesh network to the second station in the mesh network for initiating a communication between the first and second station, wherein the PREQ frame comprises a limited number of mesh awake windows—MAWs—defining a MAW map for each available communication channel and a quality of service—QoS—class indicating a desired level of quality of the communication;
indicating MAWs available for the communication in the MAW map for each available communication channel based on the QoS class and remove congested MAWs from the MAW map for each available communication channel;
removing the entire MAW map pertaining to an available channel if too many of the available MAWs are congested based on the QoS class;
determining if the MAW map for each available communication channel is sufficient for transmitting the communication in relation to the QoS class; and
if it is determined that the MAW map is sufficient for transmitting the communication in relation to the QoS class:
forwarding the PREQ comprising the MAW maps for each available communication channel to the second station if it is determined that the MAW maps for each available channel is sufficient for transmitting the communication in relation to the QoS class;
and if it is determined that the MAW map is not sufficient for transmitting the communication in relation to the QoS class:
discarding the PREQ.

12. A network station comprising a controller, the network station being configured to operate as a second station in a mesh network comprising a first station and one or more intermediate stations wherein communication within the mesh network is transmitted on a plurality of communication channels;
wherein the second station is configured to receive a path request—PREQ—frame from the first or the one or more intermediate stations in the mesh network for initiating a communication between the first and second station, wherein the PREQ frame comprises a limited number of mesh awake windows—MAWs—defining a MAW map for each available communication channel and a quality of service—QoS—class indicating a desired level of quality of the communication;
wherein the second station is configured to indicate MAWs available for the communication in the MAW map for each available communication channel based on the QoS class and remove congested MAWs from the MAW map for each available communication channel;
wherein the second station is configured to remove the entire MAW map pertaining to an available channel if too many of the available MAWs are congested based on the QoS class; and
wherein the second station is configured to determine if the MAW map for each available communication channel is sufficient for transmitting the communication in relation to the QoS class;
wherein the second station is configured to determine which MAWs in the MAW map for each available communication channel should be used for the communication based on the indicated available MAWs by defining a final MAW map comprising the MAWs and the available communication channels to be used for the communication; and
wherein the second station is configured to transmit a Path reply—PREP—frame comprising the final MAW map through the intermediate station to the first station; or.
wherein the second station is configured to discard the PREQ if the second station determines that no MAWs in the MAW map should be used for the communication based on the indicated available MAWs in the MAW map for each available communication channel.

13. A method for a network station being a second station in a mesh network comprising a first station and one or more intermediate stations wherein communication within the mesh network is transmitted on a plurality of communication channels; the method comprising
receiving a path request—PREQ—frame from the first or the one or more intermediate stations in the mesh network for initiating a communication between the first and second station, wherein the PREQ frame comprises a limited number of mesh awake windows—MAWs—defining a MAW map for each available communication channel and a quality of service—QoS—class indicating a desired level of quality of the communication;
indicating MAWs available for the communication in the MAW map for each available communication channel based on the QoS class and remove congested MAWs from the MAW map for each available communication channel;
removing the entire MAW map pertaining to an available channel if too many of the available MAWs are congested based on the QoS class;
determining if the MAW map for each available communication channel is sufficient for transmitting the communication in relation to the QoS class;
determining which MAWs in the MAW map for each available communication channel should be used for the communication based on the indicated available MAWs by defining a final MAW map comprising the MAWs and the available communication channels to be used for the communication; and
transmitting a Path reply—PREP—frame comprising the final MAW map through the one or more intermediate stations to the first station; or
discarding the PREQ if the second station determines that no MAWs in the MAW map should be used for the communication based on the indicated available MAWs in the MAW map for each available communication channel.
